(19) United States
(12) Patent Application Publication
(10) Pub. No.: US 2012/0040275 A1
(43) Pub. Date: Feb. 16, 2012

(54) Fuel Cell Module and Manufacturing Method Thereof

(75) Inventors: Seung-Tae Lee, Yongin-si (KR); Jun-Won Suh, Yongin-si (KR); Ho-Jin Kweon, Yongin-si (KR); Jan-Dee Kim, Yongin-si (KR); Young-Sun Kwon, Yongin-si (KR)

(73) Assignee: SAMSUNG SDI CO., LTD., Yongin-si (KR)

(21) Appl. No.: 13/072,254

(22) Filed: Mar. 25, 2011

(30) Foreign Application Priority Data
Aug. 11, 2010 (KR) 10-2010-0077306

(51) Int. Cl. H01M 4/66; H01M 8/00

(52) U.S. Cl. 429/517; 429/535

(57) ABSTRACT

A fuel cell module includes at least one unit cell formed by sequentially stacking a first electrode current collector, a first electrode layer, an electrolyte layer, a second electrode layer and a second electrode current collector. At least one of the first and second electrode current collectors is connected to an anti-oxidation unit positioned at the exterior of the unit cell. The anti-oxidation unit includes a metal material having a higher ionization tendency than the at least one of the first and second electrode current collectors, connected to the anti-oxidation unit. Accordingly, as an anti-oxidation unit is provided to the fuel cell module in consideration of the reactivity difference between metals, the fuel cell module is designed by substituting a low-priced current collector for a high-priced current collector, so that the degree of freedom of the design of the fuel cell module is increased and manufacturing cost is decreased.

### CLAIM OF PRIORITY

This application makes reference to, incorporates the same herein, and claims all benefits accruing under 35 U.S.C. §119 from an application earlier filed in the Korean Intellectual Property Office on 11 Aug. 2010 and there duly assigned Serial No. 10-2010-0077306.

### BACKGROUND OF THE INVENTION

1. Field of the Invention

An aspect of the present invention relates to a fuel cell module and a manufacturing method thereof, and more particularly, to a fuel cell module and a manufacturing method thereof, in which the life span of the fuel cell module may be extended by preventing the oxidation of a current collector.

2. Description of the Related Art

Fuel cells are a high-efficiency, clean generation technology for directly converting hydrogen and oxygen into electric energy through an electrochemical reaction. The hydrogen may be contained in a hydrocarbon-based material such as natural gas, coal gas or methanol, and the oxygen may be contained in the air. Such fuel cells may be classified into an alkaline fuel cell (AFC), a phosphoric acid fuel cell (PAFC), a molten carbonate fuel cell (MCFC), a solid oxide fuel cell (SOFC) and a polymer electrolyte membrane fuel cell (PEMFC), depending on the kind of an electrolyte used.

The above information disclosed in this Background section is only for enhancement of understanding of the background of the invention and therefore it may contain information that does not form the prior art that is already known in this country to a person of ordinary skill in the art.

### SUMMARY OF THE INVENTION

One embodiment of the present invention provides a fuel cell module and a manufacturing method thereof, in which the life span of the fuel cell module may be extended by preventing the oxidation of a current collector.

In accordance with an aspect of the present invention, there is provided a fuel cell module including at least one unit cell formed by sequentially stacking a first electrode current collector, a first electrode layer, an electrolyte layer, a second electrode layer and a second electrode current collector, wherein at least one of the first and second electrode current collectors may be electrically connected to an anti-oxidation unit positioned at the exterior of the unit cell, and the anti-oxidation unit may include a metal material having a higher ionization tendency than the at least one of the first and second electrode current collectors.

The anti-oxidation unit may be electrically connected to the at least one of the first and second electrode current collectors through a metal wire.

The anti-oxidation unit may be electrically connected to the least one of the first and second electrode current collectors by coming in direct contact with the least one of the first and second electrode current collectors.

The anti-oxidation unit may be electrically connected to the least one of the first and second electrode current collectors by coming in direct contact with the least one of the first and second electrode current collectors, and may accommodate the at least one unit cell.

The fuel cell module may further include another anti-oxidation unit electrically connected to the least one of the first and second electrode current collectors by coming in direct contact with the least one of the first and second electrode current collectors.

The fuel cell module may further include a housing that is electrically connected to the least one of the first and second electrode current collectors by coming in direct contact with the least one of the first and second electrode current collectors, and accommodates the at least one unit cell.

The anti-oxidation unit may be connected to the housing through a switch.

The fuel cell module may further include another anti-oxidation unit which is not connected to the housing through the switch.

The at least one of the first and second electrode current collectors may be made of silver (Ag) or nickel (Ni).

In accordance with another aspect of the present invention, there is provided a manufacturing method of a fuel cell module, the method comprising steps of forming at least one unit cell by sequentially stacking a first electrode current collector, a first electrode layer, an electrolyte layer, a second electrode layer and a second electrode current collector, and electrically connecting at least one of the first and second electrode current collectors to an anti-oxidation unit positioned at the exterior of the unit cell, with the anti-oxidation unit including a metal material having a higher ionization tendency than the at least one of the first and second electrode current collectors.

The anti-oxidation unit may be electrically connected to the at least one of the first and second electrode current collectors through a metal wire.

The anti-oxidation unit may be electrically connected to the least one of the first and second electrode current collectors by coming in direct contact with the least one of the first and second electrode current collectors.

The anti-oxidation unit may be electrically connected to the least one of the first and second electrode current collectors by coming in direct contact with the least one of the first and second electrode current collectors, and may accommodate the at least one unit cell.

The fuel cell module may further include another anti-oxidation unit electrically connected to the least one of the first and second electrode current collectors by coming in direct contact with the least one of the first and second electrode current collectors.

The fuel cell module may further include a housing that is electrically connected to the least one of the first and second electrode current collectors by coming in direct contact with the least one of the first and second electrode current collectors, and accommodates the at least one unit cell.

The anti-oxidation unit may be electrically connected to the housing through a switch.

The fuel cell module may further include another spare anti-oxidation unit which is not connected to the housing through the switch.

The at least one of the first and second electrode current collectors is made of silver (Ag) or nickel (Ni).

As described above, according to embodiments of the present invention, the oxidation of a current collector is prevented, so that the life span of a fuel cell module.

Also, the performance of the fuel cell module is equalized by preventing the oxidation of the current collector and minimizing electrical loss, so that the durability of the fuel cell module may be enhanced.

Also, as an anti-oxidation unit is provided to the fuel cell module in consideration of the reactivity difference between metals, the fuel cell module is designed by substituting a low-priced current collector for a high-priced current collector conventionally used, so that the degree of freedom of the design of the fuel cell module may be increased, and manufacturing cost may be

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view showing the structure of a unit cell in a solid oxide fuel cell (SOFC) module constructed as a first embodiment of the present invention.

FIG. 2 is a longitudinal sectional view showing the structure of the unit cell in the SOFC module constructed as the first embodiment of the present invention.

FIG. 3 is a longitudinal sectional view showing the structure of a unit cell in an SOFC module constructed as a second embodiment of the present invention.

FIG. 4 is a longitudinal sectional view showing the structure of a unit cell in an SOFC module constructed as a third embodiment of the present invention.

FIG. 5 is a longitudinal sectional view showing the structure of a unit cell in an SOFC module constructed as a fourth embodiment of the present invention.

FIG. 6 is a schematic perspective view of an SOFC module constructed as a fifth embodiment of the present invention.

FIG. 7 is a schematic view of an SOFC module constructed as a sixth embodiment of the present invention.

FIG. 8 is a flow chart showing a manufacturing method of making a fuel cell module in accordance with one embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Generally, the PAFC, MCFC and SOFC are respectively referred to as first-, second- and third-generation fuel cells. The PAFC is a fuel cell using a fuel and a phosphoric acid electrolyte. Here, the fuel includes hydrogen gas containing hydrogen as a main element and oxygen in the air. The MCFC is a fuel cell operating at about 650° C. by using a molten salt as an electrolyte. The SOFC is a fuel cell operating at the highest temperature to generate electricity at the highest efficiency among the three generations of the fuel cells.

An SOFC is a fuel cell operating at a high temperature of about 600° C. to 1000° C. In comparison with other types of fuel cells, the SOFC is widely used because the position of an electrolyte is more easily controlled and the user needs not to worry about the lack of fuel, and the life span of the material forming SOFC is longer.

Such SOFCs may be classified into a cylinder type SOFC and a flat-plate type SOFC according to the shape of a unit cell. Among these SOFCs, the cylinder type SOFC is classified into an anode-supported SOFC using an anode as a support body and a cathode-supported SOFC using a cathode as a support body.

In the anode-supported SOFC, an anode current collector is positioned at the exterior of the SOFC and is continuously exposed to air. Therefore, the anode current collector of the anode-supported SOFC requires a material with strong oxidation resistance, or, a separate method capable of preventing the oxidation of the anode current collector is required.

Although it is described in embodiments that the unit cell is formed in the shape of a hollow cylinder, the shape of the unit cell is not limited thereto. For example, the unit cell may be formed in the shape of a polygonal cylinder. Also, although it is described in the embodiments that a solid oxide fuel cell (SOFC) is applied to an anode-supported fuel cell, the solid oxide fuel cell may be identically applied to a cathode-supported fuel cell.

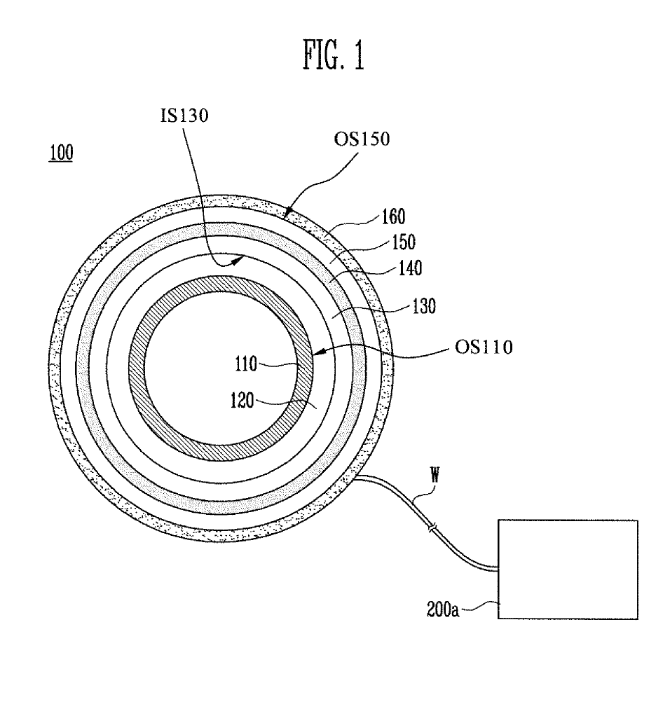

Hereinafter, SOFC modules and a manufacturing method thereof according to various embodiments of the present invention will be described with reference to FIGS. 1 through 7.

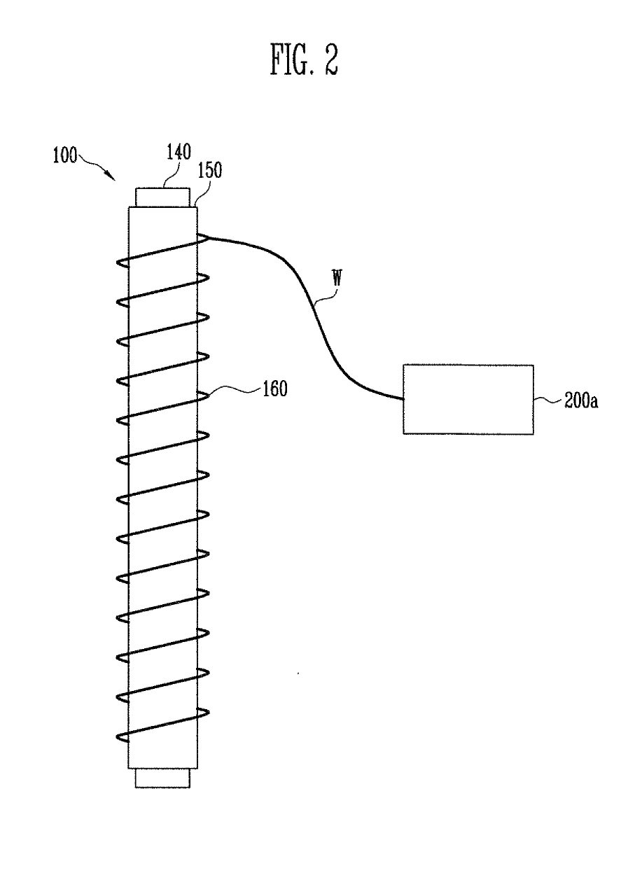

FIG. 1 is a cross-sectional view showing the structure of a unit cell in an SOFC module constructed as a first embodiment of the present invention. FIG. 2 is a longitudinal sectional view showing the structure of the unit cell in the SOFC module constructed as the first embodiment of the present invention.

Referring to FIGS. 1 and 2, the SOFC module constructed as the first embodiment of the present invention includes a unit cell 100 formed by sequentially stacking a cylindrical first electrode current collector 120, a first electrode layer 130, an electrolyte layer 140, a second electrode layer 150 and a second electrode current collector 160. In one embodiment, the first electrode layer 130 may be an anode and the second electrode layer 150 may be a cathode; in another embodiment, the first electrode layer 130 may be a cathode and the second electrode layer 150 may be an anode.

The case where the first electrode layer 130 is an anode and the second electrode layer 150 is a cathode will be described as an example. The unit cell 100 generates electricity through an electrochemical reaction of hydrogen and oxygen. Here, the hydrogen is supplied through the first electrode layer 130 that is an anode, and the oxygen is supplied to the second electrode layer 150 that is a cathode.

The first electrode current collector 120 is formed on the inner circumferential surface IS130 of the first electrode layer 130, and the second electrode current collector 160 is formed on the outer circumferential surface OS150 of the second electrode layer 150, so that the electricity generated from the unit cell 100 is supplied to an external device or a circuit through the first and second electrode current collectors 120 and 160.

In this embodiment as shown in FIG. 2, the second electrode current collector 160 may be formed in the shape of a wire spirally wound around the outer circumferential surface OS150 of the second electrode layer 150.

Various types of metal materials such as a wire, a stick, a metal pipe and a tube may be used to form the first electrode current collector 120 and the first electrode current collector 120 may be inserted into the inner circumferential surface IS130 of the first electrode layer 130. As shown in FIG. 1, the first electrode current collector 120 may be adhered closely to the inner circumferential surface IS130 of the first electrode layer 130, and the first electrode current collector 120 may be also adhered closely to the outer circumferential surface OS110 of a metal tube 110 or the like formed in the interior of the first electrode layer 130. In one embodiment, the first electrode current collector 120 may be adhered directly to the inner circumferential surface IS130 of the first electrode layer 130, and the first electrode current collector 120 may be also adhered directly to the outer circumferential surface OS110 of a metal tube 110 or the like formed in the interior of the first electrode layer 130. The various types of metal materials such as a wire, a stick, a metal pipe and a tube may be used to form the metal tube 110, and the metal tube 110 may be inserted within the inner circumferential surface IS130 of the first electrode layer 130, so that the current collection of the first electrode layer 130 may be performed, and the strength of the fuel cell may be increased. Also, the metal tube 110 or the like may be inserted into the interior of the first electrode current collector 120, so that the first electrode current collector 120 may be adhered more closely to or firmly to the inner circumferential surface IS130 of the first electrode layer 130. As a result, the strength of the fuel cell may be increased.

Here, the second electrode current collector 160 is connected to an anti-oxidation unit 200 (shown as 200a, 200b, 200c, 200d, 200e, 200e′, 200f and 200f′ in different figures corresponding to different embodiments) positioned at the exterior of the unit cell 100 through a metal wire W.

In FIGS. 1 and 2, the anti-oxidation unit 200a includes a metal material having a higher ionization tendency in comparison with that of the second electrode current collector 160. The ionization tendency refers to a tendency in which atoms or molecules would be ionized. An element having the higher ionization tendency has a higher reactivity and is easier to be oxidized in comparison with an element having a lower ionization tendency. If an element having a higher ionization tendency is reacted with an ion of an element having a lower ionization tendency, the element having the higher ionization tendency is oxidized, and the ion of the element having the lower ionization tendency is deoxidized. For example, when the second electrode current collector 160 includes nickel (Ni) and the anti-oxidation unit 200a includes zinc (Zn) or manganese (Mn) having a higher ionization tendency in comparison with the nickel, the anti-oxidation unit 200a including zinc or manganese is oxidized before the second electrode current collector 160 including the nickel is oxidized. Therefore, the anti-oxidation unit 200a formed with material having a higher ionization tendency may prevent the oxidation of the second electrode current collector 160 formed with material having a lower ionization tendency.

Through the above principle, the nickel that is relatively lower priced may be used to replace the higher priced silver (Ag) frequently used to form the electrode current collector in the related art. Thus, the cost of the electrode current collector may be reduced, and the oxidation of the electrode current collector may be prevented.

Hereinafter, SOFC modules and a manufacturing method thereof according to second through sixth embodiments of the present invention will be described with reference to FIGS. 1 and 3 through 7. In the following embodiments, descriptions overlapping with the first embodiment will be omitted, and differences with the first embodiment will be mainly described.

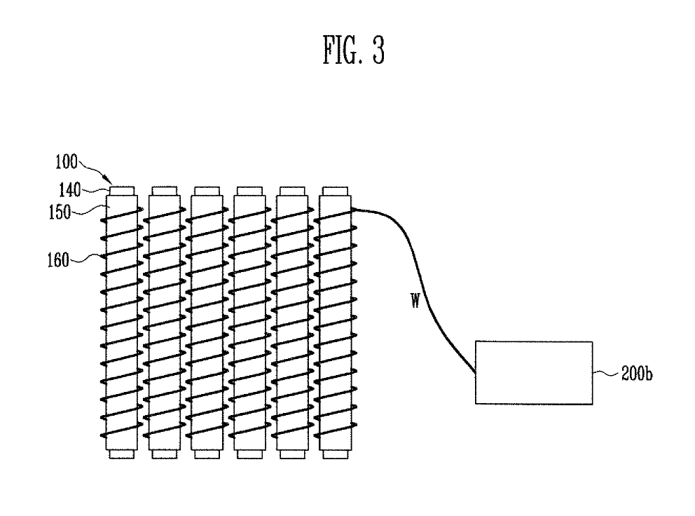

FIG. 3 is a longitudinal sectional view showing the structure of a unit cell in an SOFC module constructed as a second embodiment of the present invention.

Referring to FIGS. 1 and 3, the SOFC module constructed as the second embodiment of the present invention includes a plurality of unit cells 100, each of which is formed by sequentially stacking a cylindrical first electrode current collector 120, a first electrode layer 130, an electrolyte layer 140, a second electrode layer 150 and a second electrode current collector 160. In one embodiment, a metal tube 110 may be inserted in the 1.7 interior of the first electrode layer. 130. In another embodiment, a metal tube 110 may be inserted in the interior of the first electrode current collector 120.

Here, the plurality of second electrode current collectors 160 may be electrically connected to an anti-oxidation unit 200b positioned at the exterior of the unit cells 100 through a wire W. Since the plurality of second electrode current collectors 160 are electrically connected to one another, only one of the second electrode current collectors 160 may be directly connected to the anti-oxidation unit 200b. The other of the second electrode current collectors 160 may be connected to anti-oxidation unit 200b by this only one of the second electrode current collectors 160.

In one embodiment, the plurality of second electrode current collectors 160 may be electrically connected to one another by the wire W. A single wire W may be spirally wound in a helix around the outer circumferential surface OS150 of the second electrode layer 150 of each of the unit cell 100 in sequence. In another embodiment, the plurality of second electrode current collectors 160 may be individually formed and be electrically connected with each other by electrical conductors. Still in another embodiment, the plurality of second electrode current collectors 160 may be in direct physical and electrical contact with each other.

The anti-oxidation unit 200b includes a metal material having a higher ionization tendency in comparison with the second electrode current collector 160. Thus, the anti-oxidation unit 200b may prevent the oxidation of the second electrode current collector 160 through the same principle as the first embodiment.

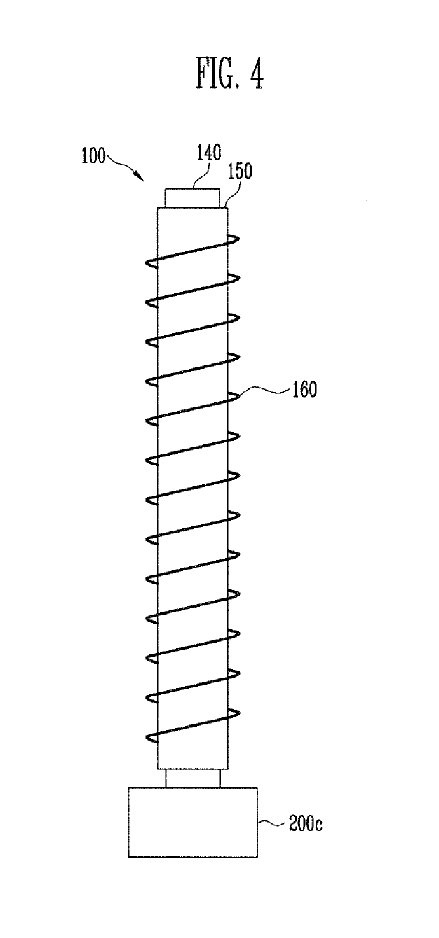

FIG. 4 is a longitudinal sectional view showing the structure of a unit cell in an SOFC module constructed as a third embodiment of the present invention.

Referring to FIGS. 1 and 4, the SOFC module constructed as the third embodiment of the present invention includes a unit cell 100 formed by sequentially stacking a cylindrical first electrode current collector 120, a first electrode layer 130, an electrolyte layer 140, a second electrode layer 150 and a second electrode current collector 160.

Here, the second electrode current collector 160 may be connected to an anti-oxidation unit 200c positioned at the exterior of the unit cell 100 and the second electrode current collector 160 may be in direct physical contact with an anti-oxidation unit 200c. In one embodiment, the electrolyte layer 140 of the unit cell 100 may be in direct physical contact with an anti-oxidation unit 200c. The anti-oxidation unit 200c includes a metal material having a higher ionization tendency in comparison with the ionization tendency of the second electrode current collector 160. Thus, the anti-oxidation unit 200c may prevent the oxidation of the second electrode current collector 160 through the same principle as the first and second embodiments.

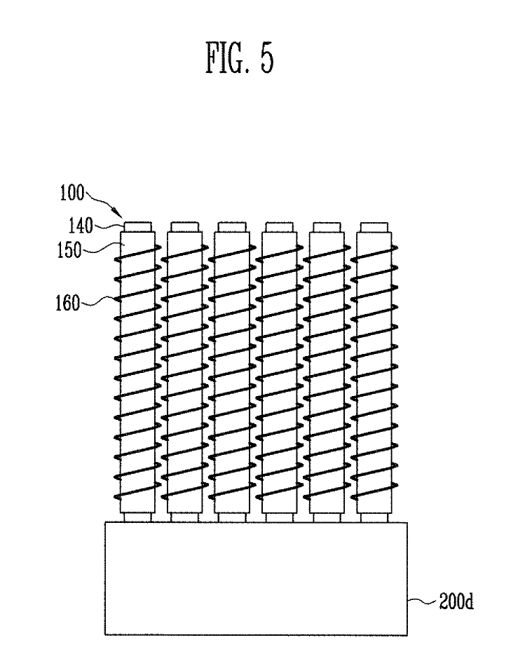

FIG. 5 is a longitudinal sectional view showing the structure of a unit cell in an SOFC module constructed as a fourth embodiment of the present invention.

Referring to FIGS. 1 and 5, the SOFC module constructed as the fourth embodiment of the present invention includes a plurality of unit cells 100, each of which is formed by sequentially stacking a cylindrical first electrode current collector 120, a first electrode layer 130, an electrolyte layer 140, a second electrode layer 150 and a second electrode current collector 160.

Here, the plurality of second electrode current collectors 160 are connected to an anti-oxidation unit 200d positioned at the exterior of the unit cells 100 and the plurality of second electrode current collectors 160 may be in direct physical contact with an anti-oxidation unit 200d. In one embodiment, the electrolyte layer 140 of the unit cell 100 may be in direct contact with an anti-oxidation unit 200d. In another embodiment, the plurality of second electrode current collectors 160 may be electrically connected to each other. The anti-oxidation unit 200d includes a metal material having a higher ionization tendency that the second electrode current collector 160. Thus, the anti-oxidation unit 200d may prevent the oxidation of the second electrode current collector 160 through the same principle as the first to third embodiments.

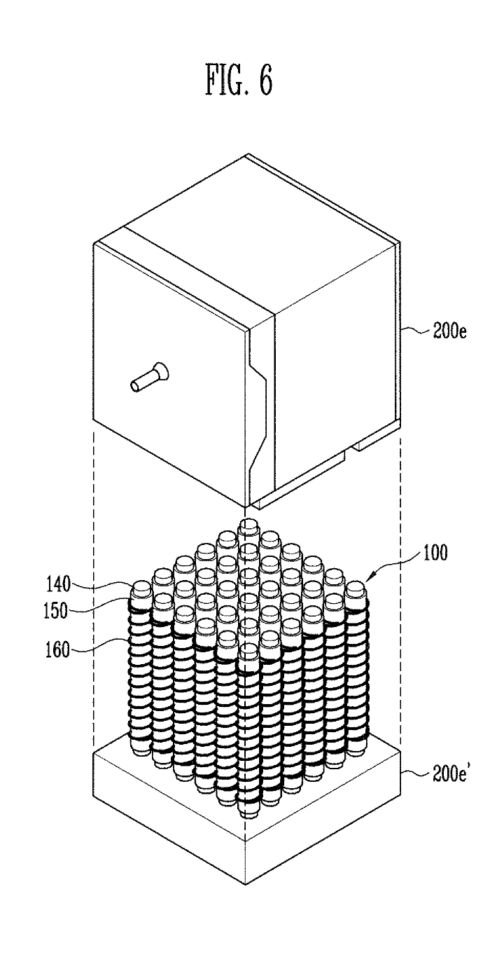

FIG. 6 is a schematic perspective view of an SOFC module constructed as a fifth embodiment of the present invention.

Referring to FIGS. 1 and 6, the SOFC module constructed as the fifth embodiment of the present invention includes a plurality of unit cells 100, each of which is formed by sequentially stacking a cylindrical first electrode current collector 120, a first electrode layer 130, an electrolyte layer 140, a second electrode layer 150 and a second electrode current collector 160.

Here, an anti-oxidation unit 200e positioned at the exterior of the unit cells 100 is connected to the second electrode current collectors 160, the anti-oxidation unit 200e may be in direct contact with the second electrode current collectors 160, and the anti-oxidation unit 200e accommodates the unit cells 100. The anti-oxidation unit 200e includes a metal material having a higher ionization tendency that the second electrode current collector 160. Thus, the anti-oxidation unit 200e may prevent the oxidation of the second electrode current collector 160 through the same principle as the first to fourth embodiments. Here, the SOFC module constructed as the fifth embodiment of the present invention may further include another anti-oxidation unit 200e′ connected to the second electrode current collectors 160 and the anti-oxidation unit 200e′ may be in direct contact with the second electrode current collectors 160. In one embodiment, the anti-oxidation unit 200e′ may be disposed to face towards the anti-oxidation unit 200; and the plurality of unit cells 100 may be disposed wholly within the combination of the anti-oxidation unit 200e′ and the anti-oxidation unit 200e.

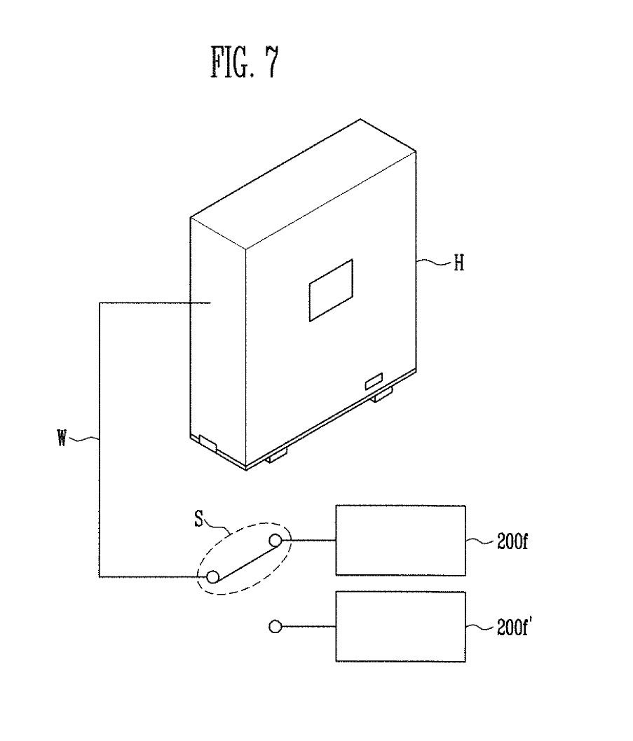

FIG. 7 is a schematic view of an SOFC module constructed as a sixth embodiment of the present invention.

Referring to FIGS. 1 and 7, the SOFC module constructed as the sixth embodiment of the present invention further includes a housing H. Here, the housing H is connected to second electrode current collectors 160, the housing H may be in direct contact with the second electrode current collectors 160, and the housing H accommodates unit cells (not shown). A plurality of unit cells 100, each of which is formed by sequentially stacking a cylindrical first electrode current collector 120, a first electrode layer 130, an electrolyte layer 140, a second electrode layer 150 and a second electrode current collector 160 as described in FIG. 1, are accommodated in the interior of the housing H.

Here, an anti-oxidation unit 200f positioned at the exterior of the unit cells 100 is electrically connected to the second electrode current collectors 160 through the S housing H and metal wire W. In this instance, the anti-oxidation unit 200f is electrically connected to the housing H through a switch S. As shown in FIG. 7, in a case where the switch S is in an on state, the anti-oxidation unit 200f is electrically connected to the second electrode current collectors 160 through the housing H. Thus, the anti-oxidation unit 200f may prevent the oxidation of the second electrode current collector 160 through the same principle as the first to fifth embodiments. Here, the SOFC module constructed as the sixth embodiment of the present invention may further include another spare anti-oxidation unit 200f′ which is not electrically connected to the housing H through the switch S in FIG. 7. When the oxidation of the anti-oxidation unit 200f connected to the housing H through the switch S is considerably advanced, the spare anti-oxidation unit 200f′ may replace the anti-oxidation unit 200f and be electrically connected to the housing H through the switch S, and in this case, the anti-oxidation unit 200f is no longer electrically connected to the housing H.

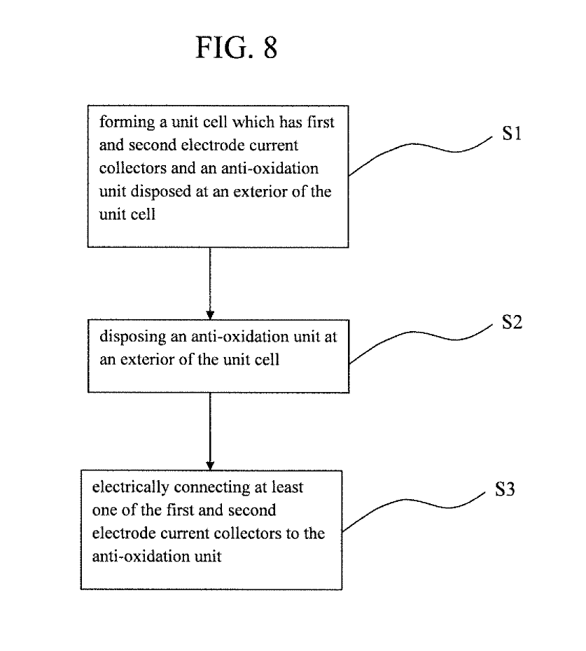

FIG. 8 shows a manufacturing method of making a fuel cell module in accordance with one embodiment of the present invention.

The procedure of making the fuel cell module includes steps of forming a unit cell by sequentially stacking a first electrode current collector, a first electrode layer, an electrolyte layer, a second electrode layer and a second electrode current collector (S1); disposing an anti-oxidation unit at an exterior of the unit cell (S2); and electrically connecting at least one of the first and second electrode current collectors to the anti-oxidation unit, with the anti-oxidation unit comprising a metal material having a higher ionization tendency in comparison with that of the at least one of the first and second electrode current collectors (S3).

As described above, according to embodiments of the present invention, the oxidation of a current collector may be prevented, so that the life span of a fuel cell module may be extended.

Also, the performance of the fuel cell module is equalized by preventing the oxidation of the current collector and minimizing electrical loss, so that the durability of the fuel cell module can be enhanced.

Also, as an anti-oxidation unit is provided to the fuel cell module in consideration of the reactivity difference between metals, the fuel cell module is designed by substituting a low-priced current collector for a high-priced current collector conventionally used, so that the degree of freedom of the design of the fuel cell module can be increased, and manufacturing cost may be reduced.

Although it has been described in the embodiments that the unit cell is formed in the shape of a hollow cylinder, the shape of the unit cell is not limited thereto. For example, the unit cell may be formed in the shape of a polygonal cylinder.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

In some of the embodiments of the present invention, term “contact” may refer to “in direct physical and intimate electrical contact with.”

What is claimed is:

1. A fuel cell module, comprising:
at least one unit cell formed by sequentially stacking a first electrode current collector, a first electrode layer, an electrolyte layer, a second electrode layer and a second electrode current collector; and
an anti-oxidation unit disposed at an exterior of the unit cell,
wherein at least one of the first and second electrode current collectors is electrically connected to the anti-oxidation unit, and the anti-oxidation unit includes a metal material having a higher ionization tendency in comparison with that of the at least one of the first and second electrode current collectors.

2. The fuel cell module according to claim 1, wherein the anti-oxidation unit is electrically connected to the at least one of the first and second electrode current collectors through a metal wire.

3. The fuel cell module according to claim 1, wherein the anti-oxidation unit is electrically connected to the least one of the first and second electrode current collectors and the anti-oxidation unit is in direct contact with the least one of the first and second electrode current collectors.

4. The fuel cell module according to claim 1, wherein the anti-oxidation unit is electrically connected to the least one of the first and second electrode current collectors, the anti-oxidation unit is in direct contact with the least one of the first and second electrode current collectors, and the anti-oxidation unit accommodates the at least one unit cell.

5. The fuel cell module according to claim 4, further comprising another anti-oxidation unit connected to the least one of the first and second electrode current collectors, and another anti-oxidation unit being in direct contact with the least one of the first and second electrode current collectors.

6. The fuel cell module according to claim 1, further comprising a housing that is electrically connected to the least one of the first and second electrode current collectors, is in direct contact with the least one of the first and second electrode current collectors, and accommodates the at least one unit cell.

7. The fuel cell module according to claim 6, wherein the anti-oxidation unit is electrically connected to the housing through a switch.

8. The fuel cell module according to claim 6, further comprising another spare anti-oxidation unit which is not electrically connected to the housing through the switch.

9. The fuel cell module according to claim 1, wherein the at least one of the first and second electrode current collectors is made of silver (Ag) or nickel (Ni).

10. A manufacturing method of a fuel cell module, the method comprising:
forming at least one unit cell by sequentially stacking a first electrode current collector, a first electrode layer, an electrolyte layer, a second electrode layer and a second electrode current collector;
disposing an anti-oxidation unit at an exterior of the at least one unit cell; and
electrically connecting at least one of the first and second electrode current collectors to the anti-oxidation unit, with the anti-oxidation unit comprising a metal material having a higher ionization tendency in comparison with that of the at least one of the first and second electrode current collectors.

11. The method according to claim 10, wherein the anti-oxidation unit is electrically connected to the at least one of the first and second electrode current collectors through a metal wire.

12. The method according to claim 10, wherein the anti-oxidation unit is electrically connected to the least one of the first and second electrode current collectors and the anti-oxidation unit is in direct contact with the least one of the first and second electrode current collectors.

13. The method according to claim 10, wherein the anti-oxidation unit is electrically connected to the least one of the first and second electrode current collectors, the anti-oxidation unit is in direct contact with the least one of the first and second electrode current collectors, and the anti-oxidation unit accommodates the at least one unit cell.

14. The method according to claim 13, wherein the fuel cell module further comprises another anti-oxidation unit electrically connected to the least one of the first and second electrode current collectors and another anti-oxidation unit is in direct contact with the least one of the first and second electrode current collectors.

15. The method according to claim 10, wherein the fuel cell module further comprises a housing that is electrically connected to the least one of the first and second electrode current collectors, is in direct contact with the least one of the first and second electrode current collectors, and accommodates the at least one unit cell.

16. The method according to claim 15, wherein the anti-oxidation unit is electrically connected to the housing through a switch.

17. The method according to claim 15, wherein the fuel cell module further comprises another spare anti-oxidation unit which is not electrically connected to the housing through the switch.

18. The method according to claim 10, wherein the at least one of the first and second electrode current collectors is made of silver (Ag) or nickel (Ni).
